(19) United States
(12) Patent Application Publication
(10) Pub. No.: US 2013/0255187 A1
(43) Pub. Date: Oct. 3, 2013

(54) HEIGHT-ADJUSTABLE CAPPING CHUCK ASSEMBLY

(71) Applicant: CLOSURE SYSTEMS INTERNATIONAL, INC., Indianapolis, IN (US)

(72) Inventors: Karl E. Zemlin, Carmel, IN (US); Larry Ellis, Cattaraugus, NY (US); Frank William Faulkenberg, Plainfield, IN (US)

(73) Assignee: Closure Systems International, Inc., Indianapolis, IN (US)

(21) Appl. No.: 13/855,754

(22) Filed: Apr. 3, 2013

Related U.S. Application Data
(60) Provisional application No. 61/619,835, filed on Apr. 3, 2012.

(51) Int. Cl. B67B 1/06

(52) U.S. Cl. CPC B67B 1/06
USPC 53/317

(57) ABSTRACT

A height-adjustable capping chuck assembly is configured for use with an associated high-speed, automated capping machine for threadingly applying closures to associated containers. The chuck assembly includes a chuck body defining a cavity for receiving a closure to be applied, and a chuck mounting sleeve by which the chuck body is mounted on the associated capping machine. An adjustable interface, preferably in the form of a threaded connection, joins the chuck body to the chuck mounting sleeve so that the height of the chuck body with respect to the associated machine can be selectively varied. A releasable locking mechanism releasably retains the chuck body in the selected orientation with respect to the chuck mounting sleeve, whereby height adjustment can be readily effected without tools, and without replacement of the capping chuck assembly, or other components.

### TECHNICAL FIELD

The present invention relates generally to capping machines for high-speed, threaded application of closures to containers, and more particularly to a capping chuck assembly for an automated capping machine, which chuck assembly facilitates precise adjustment of the height of a chuck body of the assembly, to thereby accommodate application of closures having varying height dimensions.

### BACKGROUND OF THE INVENTION

Threaded plastic closures formed from suitable polymeric materials have met with widespread acceptance in the market place for use on bottles and like containers, including those for carbonated and non-carbonated beverages. Efficient and versatile use of such closures is facilitated through the use of high-speed, automated capping equipment, which equipment is configured to rotatably apply each closure to an associated container so that an internal thread formation of the closure threadingly engages and mates with an external thread formation provided on the neck portion of the associated container.

Bottling efficiency is promoted by minimizing the down time required for maintaining and adjusting an automated capping machine. Heretofore, however, variations in the height of closures, as can vary from one style of closure to another, has typically required time-consuming replacement of all of the individual capping chuck assemblies on the capping machine. Traditional one-piece chucks are typically provided for a specific height closure, and closure height differences are accommodated by use of chucks having different lengths, or in some cases, use of selected spacer elements. Finely tuned adjustments cannot be made with one-piece chuck arrangements, thereby undesirably limiting closure usage, and the limiting the ability to accommodate and compensate for the typical variability in other parts of the capping apparatus, such as variation in lengths of the capping spindles in the machine.

Accordingly, the present invention seeks to overcome the shortcomings associated with typical one-piece chuck designs, by providing a single, selectively adjustable chuck assembly that can accommodate a range of closure heights, with the ability to make adjustments to compensate for variations in the capping machine, such as variations in the lengths of the spindles in the machine.

### SUMMARY OF THE INVENTION

In accordance with the present invention, a height-adjustable, capping chuck assembly is disclosed which greatly facilitates efficient and versatile operation of an associated high-speed capping machine, by permitting efficient adjustment of the chuck assembly to accommodate closures having varying height dimensions, such as differently styled and dimensioned closures. Capping machine down time is desirably minimized, with the present capping chuck assembly readily accommodating application of closures having widely varying height dimensions. The present chuck assembly further permits height adjustments in order to accommodate variations in the capping machine, such as variations in the lengths of the capping spindles.

In accordance with the illustrated embodiment, the present height-adjustable, capping chuck assembly includes a chuck body defining a downwardly opening cavity for receiving a closure to be applied to an associated container. The chuck assembly further includes a chuck mounting sleeve joined to the chuck body for mounting the chuck assembly in a spindle of the capping machine.

In accordance with the present invention, an adjustable interface is defined between the chuck body and the chuck mounting sleeve, which in accordance with the illustrated embodiment comprises a threaded connection joining the chuck body to the chuck mounting sleeve. In the illustrated embodiment, the chuck body defines an external thread formation, and the chuck mounting sleeve defines an internal thread formation that adjustably receives the external thread formation of the chuck body. By this arrangement, rotational, height-adjusting movement of the chuck body with respect to the chuck mounting sleeve can be readily effected.

In order to maintain the chuck body in the desired selected position with respect to the chuck mounting sleeve, the present chuck assembly includes at least one movable locking element, movable between locked and unlocked positions. In the locked position, the chuck body and the chuck mounting sleeve are locked against adjusting movement with respect to each other. In the illustrated embodiment, the locking element comprises a plurality of circumferentially spaced, locking ball detents mounted on the chuck mounting sleeve. The ball detents are movable outwardly of the chuck mounting sleeve, to the unlocked position, to permit rotational, height-adjusting movement of the chuck body with respect to the chuck mounting sleeve. Each of the ball detents is movable inwardly of the chuck mounting sleeve to the locked position thereof to lock the chuck body against rotational, height-adjusting movement with respect to the chuck mounting sleeve.

Convenient, efficient height-adjustment is effected by the provision of a selectively positionable locking collar which locks the chuck body against height-adjusting movement relative to the chuck mounting sleeve. The locking collar is movable between a first, locked position, wherein the capping chuck is locked against adjusting movement, and a second, adjustment position wherein the capping chuck can be moveably adjusted with respect to the chuck mounting sleeve. In the illustrated embodiment, the locking collar cooperates with the plurality of ball detents, such that movement of the locking collar between its locked and adjustment positions correspondingly permits movement of the ball detents between locked and unlocked positions thereof.

Efficient adjustment of the capping chuck assembly is further facilitated by the provision of an indexing collar mounted on the chuck mounting sleeve for rotation therewith. In the illustrated embodiment, the indexing collar is mounted beneath the locking collar, with the assembly including at least one biasing element positioned between the locking collar and the indexing collar. By this arrangement, the locking collar is movable downwardly toward the indexing collar, in opposition to the biasing element, when the locking collar is moved downwardly from its locked position to its adjustment position. In the illustrated embodiment, the biasing element comprises a plurality of circumferentially spaced coil springs positioned in captive relationship between the locking collar and indexing collar.

Notably, the indexing collar is adjustably mounted on the chuck mounting sleeve, with the indexing collar being upwardly moveable on the chuck mounting sleeve, in opposition to the biasing coil springs, to permit the indexing collar to be rotatably, adjustably positioned on the chuck mounting sleeve. This permits the “starting point” or “zero adjustment” height position for the chuck body to be selectively indicated by selective positioning of the indexing collar.

Other features and advantages of the present invention will become readily apparent from the following detailed description, the accompanying drawings, and the appended claims.

### BRIEF DESCRIPTION OF THE DRAWINGS

FIG. 1 is an isometric view of a height-adjustable capping chuck assembly embodying the principles of the present invention;

FIG. 2 is a side elevational view of a typical capping head with which the present capping chuck assembly can be used;

FIG. 3 is an exploded, isometric view of the present capping chuck assembly;

FIG. 4 is a cross-sectional view of the present capping chuck assembly, showing the assembly in a locked condition;

FIG. 5 is a cross-sectional vie taken along line 5-5 of FIG. 4;

FIG. 6 is a cross-sectional view similar to FIG. 4, showing the present capping chuck assembly in an unlocked condition; and

FIG. 7 is a cross-sectional view similar to FIGS. 4 and 6, illustrating a further adjustment feature of the present capping chuck assembly.

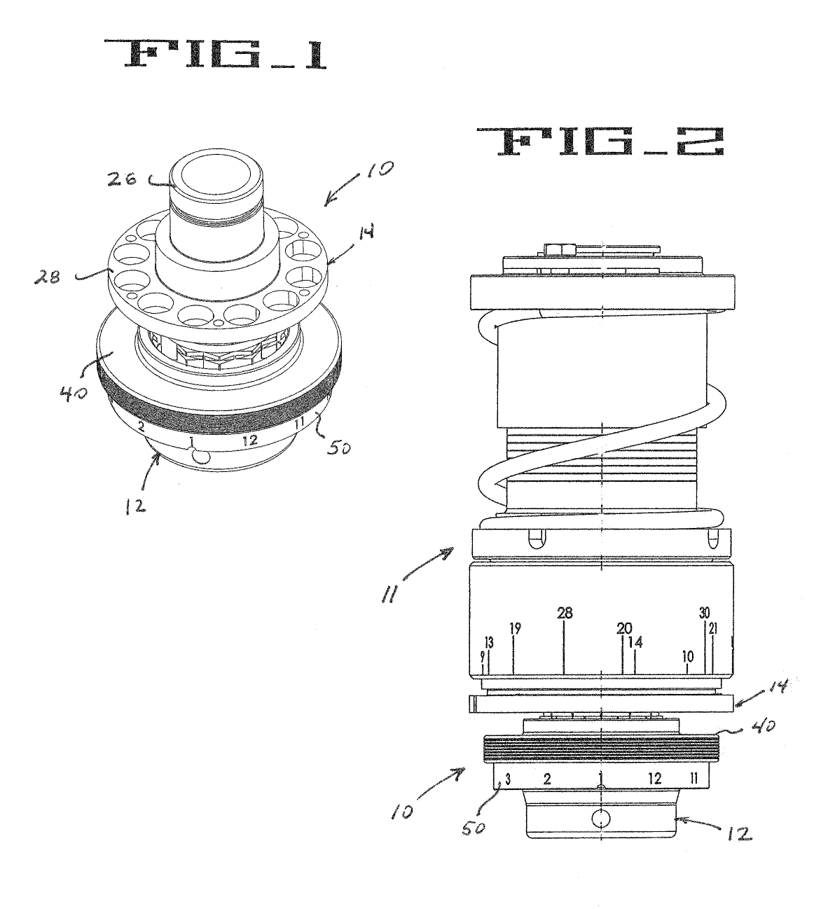

### DETAILED DESCRIPTION

While the present invention is susceptible of embodiment in various forms, there is shown in the drawings and will hereinafter be described a presently preferred embodiment, with the understanding that the present disclosure is to be considered as an exemplification of the invention, and is not intended to limit the invention to this specific embodiment illustrated.

With reference now to the drawings, therein is illustrated a height-adjustable capping chuck assembly 10 embodying the principles of the present invention. As will be appreciated by those familiar with the art, capping chuck assembly 10 is configured for use in an associated high-speed, automatic capping machine, wherein the machine comprises a plurality of rotatably driven capping spindles, each of which carries a respective one of the capping chuck assemblies. In this type of capping apparatus, the capping spindles are typically mounted on a suitable rotating turret, with each spindle rotatably driven, attendant to turret rotation, for effecting threaded application of closures to respective, filled containers. Suitable starwheels, or other transfer mechanisms, are typically provided for moving filled containers into, and away from, the capping machine. Suitable closures are provided to each of the capping chuck assemblies for application to a respective one of the containers, with the capping machine typically including suitable cams or the like, whereby each capping spindle is moved vertically attendant to turret rotation, with the closure carried by the respective capping chuck assembly rotatably threaded and applied to a respective container.

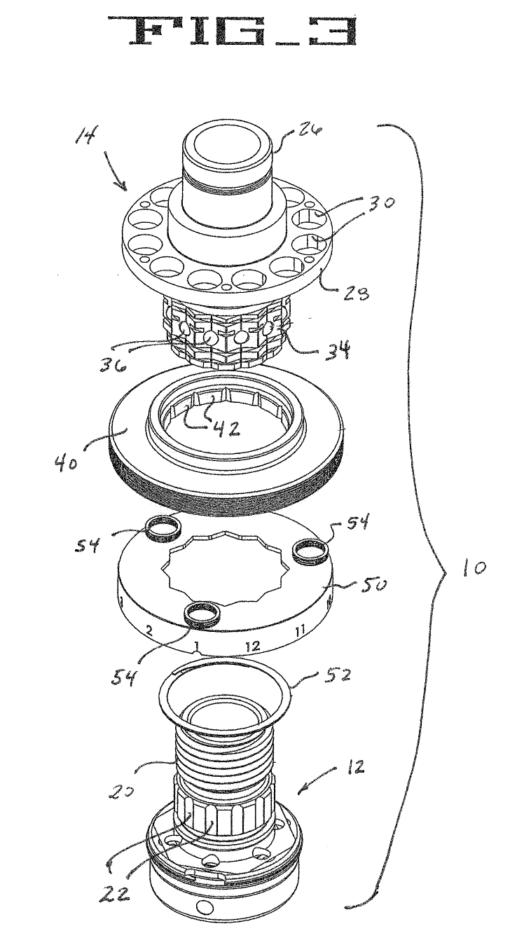

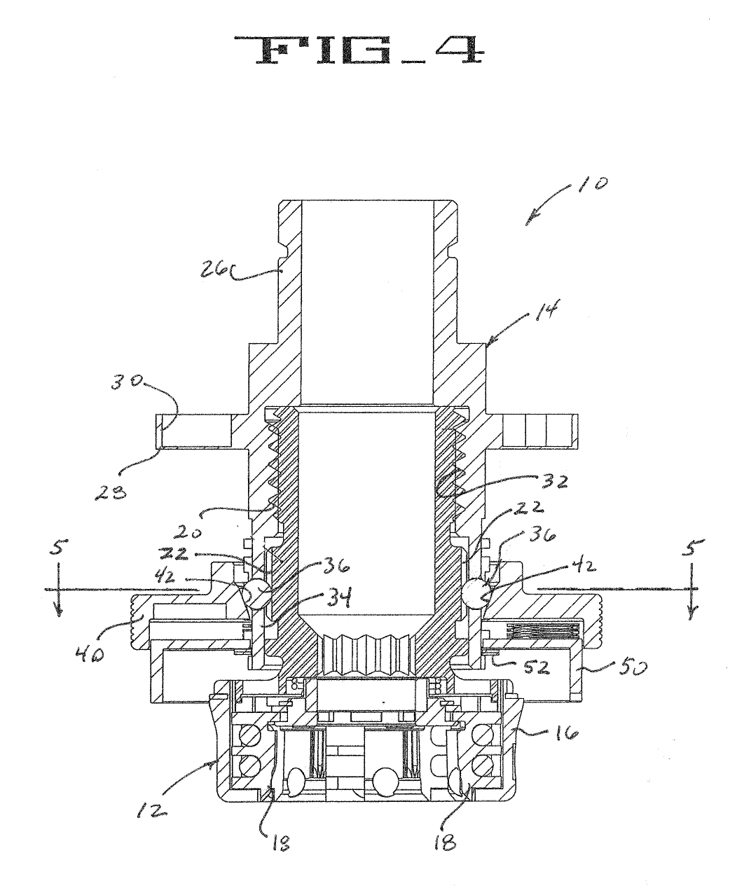

In a typical application, the present capping chuck assembly 10 is mounted in a respective torque-limiting capping head 11 (see FIG. 2), whereby each closure is applied to a respecitve container and at a specified application torque. A typical capping head with which the present capping chuck assembly can be used is available from Closure Systems International, Inc., such as Model XT6 magnetic capping head. This type of capping head includes first and second arrays of magnets having an adjustable gap therebetween, whereby the application torque of the capping head can be selectively varied by adjustment of the magnetic gap.

In accordance with the illustrated embodiment, the present capping chuck assembly includes a chuck body 12 defining a downwardly-opening cavity for receiving an associated closure, and a chuck mounting sleeve 14 for mounting the chuck body 12 in the capping head of the associated capping apparatus.

The specific configuration of the closure-receiving chuck body 12 can be varied while keeping with the principles of the present invention, by which the height of the chuck body with respect to the associated capping apparatus can be selectively varied. However, the illustrated embodiment of chuck body 12 shows a particularly preferred embodiment, wherein the chuck body includes an outer chuck housing 16 which carries a plurality of radially movable chuck jaws 18 which are configured for gripping engagement with the exterior of a closure to be applied to a container. The illustrated embodiment is configured in accordance with U.S. patent application Ser. No. 13/369,537, filed Feb. 9, 2012, the disclosure of which is hereby incorporated by reference. This particular chuck arrangement desirably accommodates variations in the external radial dimensions and/or knurl patterns of the closures. However, as noted, a differently configured chuck body can be employed for practice of the present height-adjustable, capping chuck assembly.

In order to provide the desired height adjustment of the chuck body 12 with respect to the chuck mounting sleeve 14, the chuck body 12 is provided with an external thread formation 20 at the upper portion thereof. In order to releaseably, but lockingly retain the chuck body in the selected orientation with respect to the chuck mounting sleeve, the chuck body 12 defines a plurality of axially extending, circumferentially spaced locking grooves 22, preferably positioned beneath the external thread formation 20. As will be further described, these locking grooves cooperate with at least one locking element provided on the chuck mounting sleeve 14 to releaseably maintain the chuck body in the desired orientation with respect to the chuck mounting sleeve.

The chuck mounting sleeve 14 is configured for operative mounting in the associated capping head 11, to this end, includes a threaded shank 26 at the upper portion thereof. The chuck mounting sleeve 14 includes a radially extending flange portion 28 which, in the illustrated embodiment defines a plurality of circumferentially spaced magnet cavities 30, which respectively receive one of the first and second arrays of permanent magnets to provide the desired torque-limiting, clutch-like action which is employed for applying closures to the desired torque on respective containers.

Rotatably adjustable mounting of the chuck body 12 on the chuck mounting sleeve 14 is provided by an internal thread formation 32 provided on the chuck mounting sleeve. By this arrangement, an adjustable interface is thus provided between the chuck body 12 and the chuck mounting sleeve 14, with the adjustable interface provided in the form of the threaded connection, including external thread formation 20 and internal thread formation 32, joining the chuck body 12 to the chuck mounting sleeve 14.

The chuck mounting sleeve 14 includes a locking portion 34, which, in the illustrated embodiment, is positioned generally beneath the internal thread formation 32. The locking portion 34 defines a plurality of circumferentially spaced, axially extending teeth, with circumferentially spaced openings in the locking portion 34 respectively receiving a plurality of circumferentially spaced ball detents 36. Each of the ball detents 36 is movable inwardly and outwardly of the locking portion 34 of the chuck mounting sleeve between locked and unlocked positions. As illustrated, in the inward, locked position of the ball detents 36, each of the ball detents is in engagement with a respective one of the locking grooves 22 provided on the chuck body 12. Thus, in the inward, locked position of the ball detents, the ball detents engage the locking grooves 12 to lock the chuck body against rotational, height-adjusting movement of the chuck body with respect to the chuck mounting sleeve 14.

In order to releasably retain each of the ball detents 36 in its inward, locked position, the capping chuck assembly 10 includes a vertically moveable locking collar 40 mounted on the locking portion 34 of the chuck mounting sleeve 14. The inner surface of the locking collar 40 defines a plurality of teeth which mesh with and engage the teeth defined by the external surface of the locking portion 34 of the chuck mounting sleeve 14. By this arrangement, the locking collar 40 is fixed against rotation relative to the chuck mounting sleeve 14.

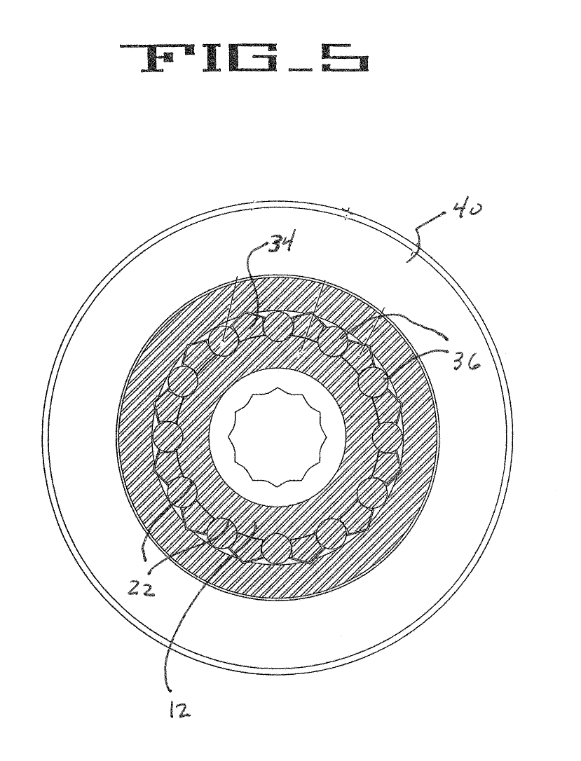

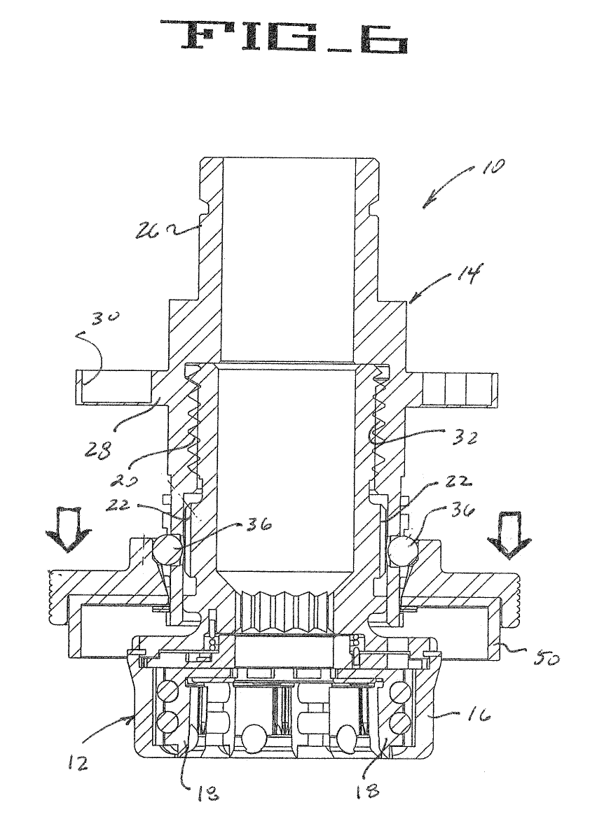

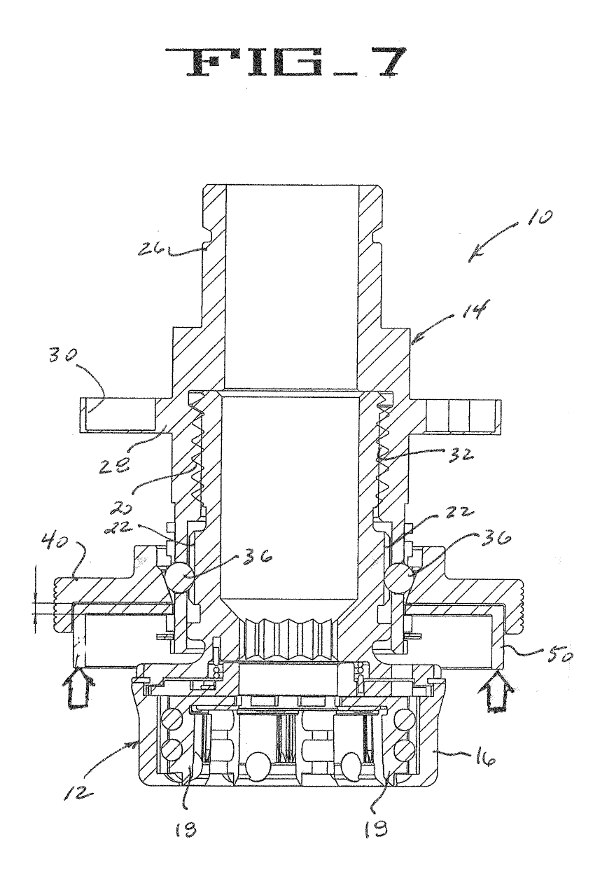

As illustrated, the inwardly extending teeth of the locking collar 40 respectively define cam surfaces 42, which cam surfaces 42 are in respective engagement with the ball detents 36. Thus, vertical movement of the locking collar 40, between an upper, locked position, and a lower, adjustment position, correspondingly permits movement of each ball detent 36 from an inner, locked position, in engagement with a respective locking groove 22 on chuck body 12, to an outward, unlocked position. FIG. 4 illustrates locking collar 40 in its upper, locked position, with ball detents 36 in their inward, locked position in engagement with locking grooves 22 on chuck body 12. In contrast, FIG. 5 illustrates locking collar 40 in its lower, adjustment position, with ball detents 36 having moved outwardly to their unlocked position, out of locking grooves 22, whereby chuck body 12 can be rotatably positioned for height-adjusting, rotational movement relative to chuck mounting sleeve 14, as external thread formation 20 is rotated within internal thread formation 32.

In the preferred embodiment, the locking collar 40 is spring-loaded into its upper locked position, with at least one biasing element provided for urging the locking collar 40 upwardly into its locked position. To this end, the capping chuck assembly 10 includes an indexing collar 50, positioned on a retention clip 52, on the chuck mounting sleeve 14. A biasing element, in the form of a plurality of circumferentially spaced coil springs 54 (three in the illustrated embodiment) are held in captive relationship between the locking collar 40 and the indexing collar 50, thereby urging the locking collar upwardly to its locked position, and urging the ball detents 36 inwardly to their locked positions.

Indexing collar 50 is preferably provided with suitable indicia to indicate the position of the chuck body 12 with respect to the chuck mounting sleeve 14. In order to provide a “starting point” or “zero position” for the chuck assembly, it is preferred that the indexing collar 50 is adjustably mounted on the chuck mounting sleeve 14. To this end, the indexing collar defines a plurality of inwardly extending teeth, which ordinarily engage the teeth defined by locking portion 34 of chuck mounting sleeve 14, whereby the indexing collar rotates together with the chuck mounting sleeve. However, as illustrated in FIG. 7, the indexing collar 50 can be moved upwardly, in opposition to coil springs 50, whereby the indexing collar is aligned with a non-toothed, grooved region of locking portion 34 of chuck mounting sleeve 14. In this upper position of the indexing collar 50, the indexing collar can be selectively rotated relative to the chuck mounting sleeve 14, whereby the “zero position” of the indexing collar can be selectively rotatably, adjustably positioned on the chuck mounting sleeve. When the indexing collar is in the desired position, and its teeth aligned with the teeth on the locking portion 34 of the chuck mounting sleeve, the indexing collar can again be lowered so that it is fixed against rotation with respect to the chuck mounting sleeve 14.

From the foregoing, use and adjustment of the present height-adjustable capping chuck assembly will be readily appreciated. Selective positioning of indexing collar 50 on chuck mounting sleeve 14 permits an operator to establish a “zero position” for the adjustable chuck assembly. Selective adjustment of the height of the closure-receiving chuck body 12 can be readily effected by unlocking the assembly by downward movement of locking collar 40, thereby permitting ball detents 36 to move out of locking engagement with the locking grooves 20 defined by the chuck body 12. By virtue of the threaded connection provided between the chuck mounting sleeve 14 and the chuck body 12 by internal thread formation 32 and external thread formation 20, relative rotation of the chuck body and the mounting sleeve selectively adjusts the height (i.e., vertical positioning) of the chuck body 12 with respect to the associated capping apparatus. Depending upon the specific configuration of the assembly, including the specific thread pitch of the mating internal and external thread formations 32, 20, a typical arrangement will permit height adjustments in increments of 0.010 inches, with an adjustment range in excess of 0.12 inches.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

What is claimed is:

1. A height-adjustable, capping chuck assembly, comprising:
a chuck body defining a downwardly opening cavity for receiving a closure to be applied to a container; and
a chuck mounting sleeve joined to said chuck body for mounting said chuck assembly in an associated capping machine,
said chuck body and said chuck mounting sleeve together defining an adjustable interface therebetween, whereby the height of the chuck body within the associated capping machine can be selectively varied to accommodate application of closures having varying height dimensions.

2. A height-adjustable, capping chuck assembly in accordance with claim 1, wherein
said adjustable interface comprises a threaded connection joining said chuck body to said chuck mounting sleeve.

3. A height-adjustable, capping chuck assembly in accordance with claim 2, wherein
said chuck body defines an external thread formation, and said chuck mounting sleeve defines an internal thread formation that adjustably receives said external thread formation on said chuck body, said thread formations together providing said threaded connection of said adjustable interface of said capping chuck assembly.

4. A height-adjustable, capping chuck assembly in accordance with claim 1, including
a selectively positionable locking collar for locking said chuck body against height-adjusting movement relative to said chuck mounting sleeve, said locking collar being movable between a first, locked position, wherein said chuck body is locked against a adjustment movement with respect to said chuck mounting sleeve, and a second, adjustment position wherein said chuck body can be movably adjusted with respect to said chuck mounting sleeve.

5. A height-adjustable, capping chuck assembly in accordance with claim 4, including
at least one movable locking element on said chuck mounting sleeve, said locking element being movable between locked and unlocked positions attendant to selective movement of said locking collar between said locked and adjustment and positions.

6. A height-adjustable, capping chuck assembly in accordance with claim 4, including
a plurality of locking ball detents mounted on said chuck mounting sleeve in circumferentially spaced relationship, said ball detents being movable outwardly of said chuck mounting sleeve when said locking collar is moved from said locked position into said adjustment position to permit adjusting movement of said chuck body with respect to said chuck mounting sleeve, said ball detents being inwardly movable when said locking collar is moved from said adjustment position to said locked position to lock said chuck body against adjusting movement with respect to said chuck mounting sleeve.

7. A height-adjustable, capping chuck assembly in accordance with claim 4, including
an indexing collar having a least one indicia thereon for indicating the height position of said chuck body with respect to said chuck mounting sleeve.

8. A height-adjustable, capping chuck assembly in accordance with claim 7, wherein
said indexing collar is mounted on said chuck mounting sleeve for rotation therewith.

9. A height-adjustable, capping chuck assembly in accordance with claim 7, wherein
said indexing collar is mounted beneath said locking collar, said capping chuck assembly including at least one biasing element positioned between said locking collar and said indexing collar, said locking collar being movable toward said indexing collar, in opposition to said biasing element, when said locking collar is moved downwardly from said locked position to said adjustment position.

10. A height-adjustable, capping chuck assembly, comprising:
a chuck body defining a downwardly opening cavity for receiving a closure to be applied to a container;
a chuck mounting sleeve joined to said chuck body for mounting said chuck assembly in an associated capping machine,
said chuck body and said chuck mounting sleeve together defining an adjustable interface therebetween comprising a threaded connection joining said chuck body to said chuck mounting sleeve; and
at least one movable locking element, said locking element being movable between locked positions and unlocked positions, wherein in said locked position, said chuck body and said chuck mounting sleeve are locked against adjusting movement with respect to each other, and in said unlocked position, said chuck body can be selectively, rotationally positioned with respect to said chuck mounting sleeve,
whereby the height of the chuck body within the associated capping machine can be selectively varied, by rotational, height-adjusting movement of said chuck body with respect to said chuck mounting sleeve to accommodate application of closures having varying height dimensions.

11. A height-adjustable, capping chuck assembly in accordance with claim 10, including
a selectively positionable locking collar mounted on said chuck mounting sleeve for locking said chuck body against height-adjusting movement relative to said chuck mounting sleeve, said locking collar being movable between a first, locked position, wherein said locking element is maintained in said locked position thereof so that said capping chuck is locked against a rotational, height-adjusting movement with respect to said chuck mounting sleeve, and a second, adjustment position wherein said locking element is movable to said unlocked position to permit said capping chuck to be movably adjusted with respect to said chuck mounting sleeve.

12. A height-adjustable, capping chuck assembly in accordance with claim 11, including
an indexing collar mounted on said chuck mounting sleeve beneath said locking collar, said indexing collar having a least one indicia thereon for indicating the height position of said chuck body with respect to said chuck mounting sleeve,
said capping chuck assembly including at least one biasing element positioned between said locking collar and said indexing collar, said locking collar being movable toward said indexing collar, in opposition to said biasing element, when said locking collar is moved downwardly from said locked position to said adjustment position.

13. A height-adjustable, capping chuck assembly in accordance with claim 11, wherein
said locking element comprises a plurality of locking ball detents mounted on said chuck mounting sleeve in circumferentially spaced relationship, said ball detents being movable outwardly of said chuck mounting sleeve when said locking collar is moved from said locked position into said adjustment position to permit rotational, height-adjusting movement of said chuck body with respect to said chuck mounting sleeve, said ball detents being inwardly movable when said locking collar is moved from said adjustment position to said locked position to lock said chuck body against rotational, height-adjusting movement with respect to said chuck mounting sleeve.

14. A height-adjustable, capping chuck assembly in accordance with claim 12, wherein
said biasing element comprises a plurality of circumferentially spaced coil springs.

15. A height-adjustable, capping chuck assembly in accordance with claim 10, wherein
said threaded connection comprises an external thread formation defined by said chuck body, and an internal thread formation defined by said chuck mounting sleeve.

16. A height-adjustable, capping chuck assembly in accordance with claim 12, wherein
said indexing collar is adjustably mounted on said chuck mounting sleeve, said indexing collar being upwardly movable on said chuck mounting sleeve, in opposition to said biasing element, to permit said indexing collar to be rotatably adjustably positioned on said chuck mounting sleeve.
